(19) United States
(12) Patent Application Publication
(10) Pub. No.: US 2009/0004550 A1
(43) Pub. Date: Jan. 1, 2009

(54) In situ fabricated electrochemical device

(76) Inventors: Eric W. McFarland, Santa Barbara, CA (US); Horia Metiu, Santa Barbara, CA (US); Steven K. Burotto, Goleta, CA (US); Asanga Devinda Ranasinghe, Henderson, NV (US)

Correspondence Address: BERLINER & ASSOCIATES, 555 WEST FIFTH STREET, 31ST FLOOR, LOS ANGELES, CA, 90013, US

(21) Appl. No.: 12/074,084

(22) Filed: Feb. 29, 2008

Related U.S. Application Data
(60) Provisional application No. 60/904,604, filed on Mar. 1, 2007.

(51) Int. Cl. H01M 4/86; H01M 4/88

(52) U.S. Cl. 429/40; 427/457

(57) ABSTRACT

An electrochemical device, such as a fuel cell, and method of forming it, in which electrodes, such as anode and cathode, are disposed on a semipermeable or permeable membrane having ion conduction channels. Electrocatalyst is deposited on locations on the electrodes limited to and corresponding to the ion conduction channels. In a first embodiment, anode and cathode electrodes sandwich the membrane, a counter electrode is connected to one of the electrodes, electrolyte containing an electrochemical precursor to the electrocatalyst is applied to the other electrode whereby, upon applying current to the counter electrode, electrocatalyst is deposited on locations on the first electrode corresponding to the ion conduction channels. The process is repeated with the counter electrode connected on the other electrode of the cell. In a second embodiment, a combination of a first electrode and a first membrane is assembled as is a combination of a second electrode and a second membrane. A counter electrode and electrolyte containing an electrochemical precursor to the electrocatalyst are separately applied to the first combination, then the second combination whereby, upon applying current to the counter electrodes, electrocatalyst is deposited on locations on the first and second electrodes corresponding to the ion conduction channels. The surfaces of the first and second membranes are joined opposite their respective electrodes to a porous coupling layer to form the electrochemical device.

### CROSS REFERENCE TO RELATED APPLICATION

This application claims the benefit of U.S. Provisional Patent Application No. 60/904,604 filed Mar. 1, 2007, which application is herein incorporated by reference.

### STATEMENT REGARDING FEDERALLY FUNDED RESEARCH OR DEVELOPMENT

This invention was made with Government support under Grant No. DAAD 19-03-1-0121 from the United States Army Research Office. The Government has certain rights in the invention.

### FIELD OF THE INVENTION

The invention relates to fuel cells.

### BACKGROUND OF THE INVENTION

A fuel cell is a device whereby the energy produced by chemical reactions of a gaseous or liquid feed material is converted directly to electric energy. Some fuel cells consist of a membrane electrode assembly (MEA) formed by a polymer electrolyte membrane and a pair of electrodes with catalyst on them, located at each side of the membrane. The structural art for fuel cells is well developed, as illustrated by U.S. Pat. Nos. 6,893,767 (“Methods for Producing Fuel Cell Units and Fuel Cell Stacks) and 7,157,176 (Membrane-Electrode Assembly for Polymer Electrolyte Fuel Cell, and Process for its Production), the disclosures of which are incorporated herein by reference.

A useful membrane, among others, is Nafion®, a sulfonated tetrafluorethylene copolymer manufactured by DuPont de Nemours. One form can be referred to as tetrafluoroethylene-perfluoro-3,6-dioxa-4-methyl-7-octenesulfonic acid copolymer, represented more generally by the following structure where x, y, and z are dependent on processing conditions:

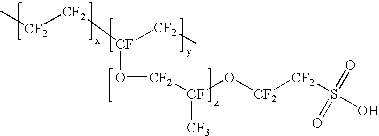

It is one of a class of synthetic polymers with ionic properties which are called ionomers. Nafion has excellent thermal and mechanical stability. Its ionic properties are a result of incorporating perfluorovinyl ether groups terminated with sulfonate groups onto a tetrafluoroethylene (Teflon) backbone. In presence of humidity the polymer membrane forms aqueous domains, hereby called channels, consisting of water, protons and SO₃H (sulfonic acid) groups. The protons can move through the channel and if the channel traverses the membrane they will produce an ionic current when the membrane is under an electrical potential. This electric conductivity is essential for the function of the fuel cell.

Fuel cells and other electrochemical devices that make use of semipermeable or permeable membranes (such as Nafion) affixed to electrodes on which an electrocatalyst is deposited, have limitations. In existing fuel cells the catalysts are deposited first on the electrodes of the cell and then the membrane is placed between the electrodes. In general, any membrane will contain channels through which the protons have to travel. In the specific case of Nafion or other polymeric membranes proton migration takes place through hydrophilic domains consisting of water, protons and sulfonic groups. The catalyst consists of very small metal particles (e.g. Pt/Ru and Pt) at both anode and cathode. These are supported on small carbon particles which are, in turn, supported by a carbon cloth that serves as an electrode. When the membrane is pressed against the carbon cloth, to make the cell, there is no reason why the catalyst particles (e.g. Pt/Ru and the Pt) will be in contact with a hydrophilic domain or an ion conducting domain in a ceramic or other type of membrane. The electrocatalytic process, that makes the cell function, requires that protons are made at the anode and travel through the membrane to the cathode where they are reduced. The catalyst particles that are located in a hydrophobic domain (or under the ceramic wall in other membranes) cannot produce protons, hence electricity. The ones that are located in a hydrophilic domain (channel) that crosses the membrane produce electricity only if the domain has a catalyst particle at each end of the channel. All catalyst particles (e.g. Pt and Pt/Ru) that do not satisfy this condition are wasted. This poor utilization of the catalyst increases the cost of the cell. Our measurements estimate that about 40% of the Pt particle do not participate in the electrochemical current production.

Moreover, it is difficult to control the size of the conventional platinum catalyst currently used in fuel cells. The activity of the catalyst takes place on its surface and if the particles are too large the ratio of surface to volume is large and the Pt inside the particle is wasted (it does not contribute to the chemical activity but it adds to the cost).

In U.S. Pat. No. 4,959,132 (“Preparing In Situ Electrolyte Membranes, . . . ”), a polymer electrolyte membrane such as Nafion is impregnated with an ionic salt of a desired catalyst, such as Pt(NH₃)₄Cl₂ is by saturating the membrane with a solution of the ionic salt, the metal ions moving into the membrane by ion exchange. This is followed by a reduction step by placing the membrane between a non-reactive medium such as nitrogen gas and a liquid containing a reductant to form an electrostatic film proximate to the surface of the membrane by diffusion of the ions. The resulting membrane is not useful for direct electrochemical reaction because of the electrical isolation of the particles. A bi-polar structure including a pair of electrocatalytic films proximate both surfaces are connected to anode and cathode simultaneous oxidation and reduction in a chloroalkai system. The method is not suggested for fuel cells and indeed would be similarly wasteful as described above with respect to catalysts deposited first on the electrodes of the cell and then contacted with a membrane, because, as described above, catalyst particles that are located in a hydrophobic domain cannot produce protons.

A need exists therefore to better utilize the electrocatalysts by placing it in the conducting channels, and to control the size of the catalyst particles to optimize current production per mass of platinum.

### BRIEF SUMMARY OF THE INVENTION

The present invention fulfills the foregoing needs and overcomes the foregoing drawbacks to greatly benefit both the cost and efficiency of such devices, by applying electrocatalyst to the electrode after a membrane containing ion conducting channels is attached. By depositing catalyst after the membrane is attached, the deposition of the electrocatalyst is such that it ensures that all catalyst particles in the cell are in contact with the conducting areas of the membrane. In addition the method of preparation allows a fine control of the size of the catalyst particles.

An electrochemical device is thus provided, such as a fuel cell, and a method of forming it, so that the catalyst particles are deposited only in those conducting channels of the membrane that cross the membrane and have good electrical contact with the carbon cloth membrane. We do this by depositing the catalyst on the carbon cloth electrochemically. This electrochemical deposition is done so that the ions that will form the catalyst deposits on the electrode, reach the electrode through the conducting channels of the membrane. In this way the catalyst particles can be formed only on those parts of the carbon cloth electrode that are in contact with the ion conducting channels in the membrane. Because of this all catalyst particle are able to participate in electricity production in the fuel cell. The catalyst is deposited successively first on one cell electrode then on the other.

In one embodiment a polymeric membrane fuel cell is prepared that has the carbon cloth electrodes and the membrane in place but it does not have the catalyst on the carbon cloth electrodes. The catalyst is then deposited on the carbon cloth electrochemically in a way that ensures that the catalyst particles are all in the ion conducting channels of the membrane. A second embodiment makes two half-cells that have the carbon cloth electrodes but no catalyst and then deposits the catalyst particle electrochemically through the membrane. After catalyst has been deposited in each half-cell, the half-cells are pressed together through a porous coupling layer. These procedures can be used for any electrodes (not necessarily carbon cloth) and for any membrane (not necessarily Nafion or polymeric).

In an alternative embodiment, what can be called “split-join” synthesis, catalyst particles are deposited from their respective ion solutions onto half membrane electrode assemblies, which are then coupled through a porous coupling layer to provide continuous pathways for ion transport across the membrane.

The invention comprises a method of making fuel cells and other electrochemical devices that require electrocatalysts in contact with a membrane as used in a variety of electrochemical devices including specifically fuel cells. The invention consists of a method of producing an electrochemical device with one or more electrodes which contain electrocatalysts prepared by the unique methodology of this invention.

### BRIEF DESCRIPTION OF THE DRAWINGS

For a more complete understanding of the present invention, reference is now made to the accompanying drawings, in which:

FIG. 1 is a schematic ion conduction channel model of a membrane used in a fuel cell of the invention;

FIG. 2 is a schematic depiction of an assembled polymer electrolyte membrane (“PEM”) used in ion channel guided electrocatalyst deposition in accordance with a first embodiment of the invention;

FIG. 3 is a schematic depiction of the electrolytic deposition of Pt through the PEM channels on to the (right) electrode which is biased relative to a counter electrode on the opposite (33 far left);

FIG. 4 is a schematic depiction of the electrolytic deposition of Pt/PtRuO on the second (right) PEM electrodes using a counter electrode (42 far left);

FIG. 5 is a schematic depiction of a working fuel cell prepared in accordance with this embodiment of the invention;

FIGS. 6a-6c are schematic depictions of the assembly of a fuel cell in accordance with a second embodiment of the invention. Individual cathode and anode catalysts are first deposited separately using counter electrodes (65 and XX), then the two half cells are joined using a coupling layer composed of a material that is porous allowing free exchange of ions including but not limited to, porous silica, mesoporous alumina, or silica fibers, or, ion selective gels or other ionic exchange materials (67) in a split-join synthesis of the fuel cell;

FIG. 7 is a plot of voltage versus current for a fuel cell of this embodiment, showing characteristics of the fuel cell (as a H₂ fuel cell).

FIG. 8 shows, separately, the cyclic voltammetry for oxidation of methanol for each electrode at different deposition times.

FIG. 9 depicts a series of scanning electron micrographs showing evidence of smaller particle size with increased surface area obtained by decreasing the pH of the electrolyte.

### DETAILED DESCRIPTION OF THE INVENTION

The invention calls for depositing catalyst after an ion conducting membrane is attached to an electrode, so as to ensure that all catalyst particles in the cell are in contact with the conducting areas of the membrane. The catalyst particles are deposited only in those conducting channels of the membrane that cross the membrane and have good electrical contact with a carbon cloth electrode by depositing the catalyst on the carbon cloth electrochemically. The ions that will form the catalyst reach the electrode through the conducting channels of the membrane. In this way the catalyst particles can be formed only on those parts of the carbon cloth electrode that are in contact with the ion conducting channels in the membrane so that all catalyst particle are able to participate in electricity production in the fuel cell.

The catalyst is deposited successively first on one cell electrode then on the other. The size of the catalyst particles is varied and controlled by adjusting the pulse sequence in the electrochemical deposition, the concentration of the salt used to provide the catalyst cations during deposition, and the duration of the electrolysis. In the first embodiment of this concept we prepare a polymeric membrane fuel cell that has the carbon cloth electrodes and the membrane in place but it does not have the catalyst on the carbon cloth electrodes. The catalyst is then deposited on the carbon cloth electrochemically in a way that ensures that the catalyst particles are all in the ion conducting channels of the membrane. A second embodiment makes two half-cells that have the carbon cloth electrodes but no catalyst and then deposits the catalyst particle electrochemically through the membrane. After catalyst has been deposited in each half-cell, the half-cells are pressed together through a porous coupling layer. These procedures can be used for any electrodes (not necessarily carbon cloth) and for any membrane (not necessarily Nafion or polymeric).

More specifically, the catalytic particles are prepared by electrolysis. The membrane is first placed between the two electrodes (e.g. carbon cloth, with or without carbon particles on them—or any other electrode used in making a fuel cell), which is then impregnated with a solution containing the salt of the catalyst metal to be deposited. Such a solution can be, for example, PtCl₆H₂ if Pt is the catalyst. In general one can use any salt of any metal that one wants to deposit. However acids similar to PtCl₆H₂ are preferable because the positive ions are protons and the negative ion PtCl₆²⁻ does not harm the membrane because the —SO₃⁻ ions in the membrane are chemically tied to the walls of the conducting channels and cannot be pushed out of the membrane by PtCl₆²⁻. Had we used another salt which contained a cation we would run the risk that the cation expels the protons from the conducting channels of the membrane. If that were to happen the protons have to be put back in the membrane by ion exchange performed after catalyst deposition. The salt is then electrolyzed to deposit the metal catalyst on one of the electrodes (e.g. carbon cloth). In this way the catalytic particles are formed only inside those channels that cross the membrane, i.e., in this case, the hydrophilic domains. As a result, no catalytic particles are wasted. Moreover, one has very good control of the size of the formed particles by applying a sequence of voltage pulses of adjustable magnitude and duration.

In an alternative embodiment, what can be called “split-join” synthesis, catalyst particles are deposited from their respective ion solutions onto half membrane electrode assemblies, which are then coupled through a porous coupling layer to provide continuous pathways for ion transport across the membrane.

The invention is applicable to any ion conducting membrane and any catalyst, be it unary, binary or ternary. In those cases when spontaneous metal deposition takes place from a salt to a metal (for example a Ru salt in contact with a Pt particle will deposit metallic Ru on the Pt particle) one can deposit a second metal on top of the catalyst (deposited first by the method explained above) by exposing the MEA to the salt.

Thus in broader embodiments, the membrane can be any ion conducting membrane, semipermeable or fully permeable. A semipermeable membrane, also termed a selectively-permeable membrane, a partially-permeable membrane or a differentially-permeable membrane, is a membrane that will allow only certain molecules or ions to pass through it by diffusion, exemplified herein by Nafion. Examples of fully permeable membranes that may be used herein are porous oxides and polymers including but not limited to fritted glass, alumina (including mesoporous), glass fibers, and porous polyacrylonitrile. Moreover, while the ion conducting membrane will be illustrated herein by an ionomer, specifically, a sulfonated tetrafluoroethylene copolymer such as Nafion, the concepts of the invention are broadly applicable to any ion conducting membrane, for example functionalized mesoporous films such as mesoporous alumina or silica functionalized with per-fluorinated ligands (including Nafion-like species), hydroxylated polyols, poly(methyl methacrylate), and amine's. Other examples include commercial cation selective gels and resins.

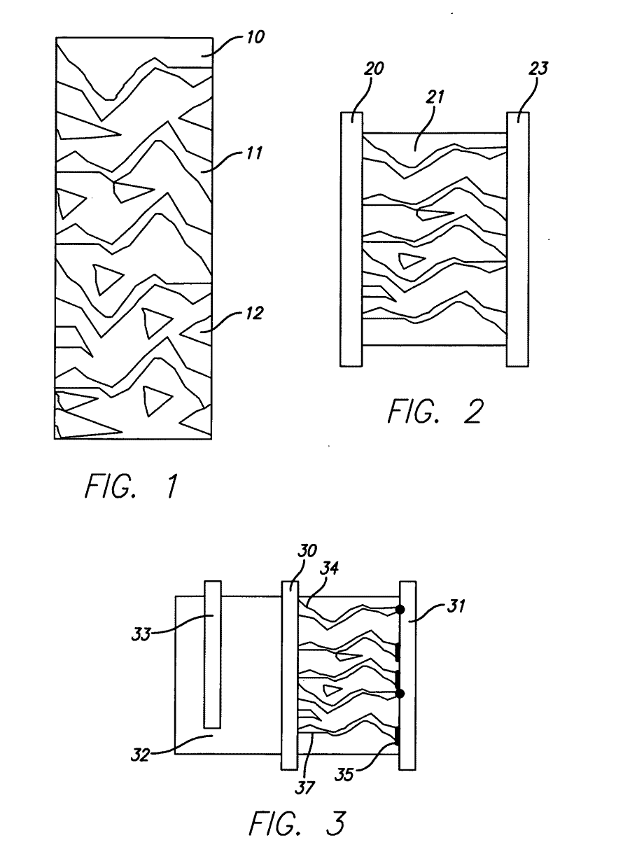

FIG. 1 is a schematic description of the conduction channels of a membrane used in a fuel cell of the invention. In this embodiment, the membrane is about 0.1 to 0.2 mm thick and has inhomogeneous conduction channels 11 and non-conducting domains 10. Only the channels 11 traversing the membrane are useful in electricity production. Channels such as 12, which do not traverse the membrane do not participate in electricity production.

FIG. 2 is a schematic depiction of an assembled polymer electrolyte membrane fuel cell without the catalyst. This is used in ion-channel guided electrocatalyst deposition, in accordance with a first embodiment of the invention. It contains a pair of conducting electrodes 20 and 22 secured, by conventional hot pressing, on the opposite sides and of a PEM 21.

FIG. 3 shows the method by which the catalyst is deposited on one of the carbon cloth electrodes 31. We start with the membrane electrode assembly consisting of the electrodes 30 and 31 and the polymeric membrane 37 constructed as described above. This is placed in contact with an electrolyte solution 32 (for example a solution of Pt(Cl)₆H₂) which has a counter electrode in it 33. Then electrochemistry is performed with 31 as the positive electrode and 33 as a counter-electrode. The Pt(Cl)₆²⁻ ions travel from the solution 32 to the electrode 31 through the conducting channels of the membrane (for example, 34 and Pt is deposited on the electrode 31. The Pt deposits are shown at 35. In this way Pt is deposited only at the mouth of channels that cross the membrane. No Pt is wasted by being deposited under non-conducting regions of the membrane or in channels that do not cross the membrane. This procedure can be used for pulsed or continuous deposition, and with any kind of electrolyte that will deposit the desired catalyst. It can also be used to deposit alloys or a film or a monolayer of a metal on top of another metal. Also, once one metal A has been deposited, the structure can be exposed to an electrolyte that contains a salt which will spontaneously decompose to deposit a metal B on A. For example, a Ru salt can be used for spontaneous deposition of Ru metal on Pt deposits prepared prior to the Ru deposition. During the deposition all sides of the cell, except the electrode 30, are blocked with a tape or any other device so that ions can penetrate the membrane only through the electrode 30 which is not under electric potential. Thus the ions are forced to travel through the conducting channels to the electrode 31 where they form metal deposits. The quality and the amount of metal can be varied by changing the voltage pulse sequence and the composition of the electrolyte solution or by pretreatment of the surface on which the metal is deposited. The membrane material 37 may comprise of an ionomer, fritted glass, or another more macroporous material that does not block the pores.

FIG. 4 shows how, after the procedure explained in FIG. 3, catalyst is deposited on the other electrode 44. Note that the electrode 43 already has catalyst particles 45 deposited in a previous step. The EMA, with catalyst deposited previously on the electrode 43, is put in contact with an electrolyte 41 and a counter electrode 42. A battery is connected to 42 and 44 and the ions from 41 are directed through the channels that traverse the membrane 47 towards the electrode 44. Metal is deposited on 44 by this process. One can use any electrolyte to deposit any element on 44. The quality and the amount of deposit can be varied by changing the voltage pulses, the deposition time and/or the composition of the electrolyte 41. Note that all channels that traverse the membrane have catalyst particles at both ends, and not catalyst is deposited under the non-conducting domains in the membrane or in channels that do not traverse the membrane. Thus no catalyst is wasted and the amount deposited and its quality are controlled by the manner in which the electrochemical deposition is conducted.

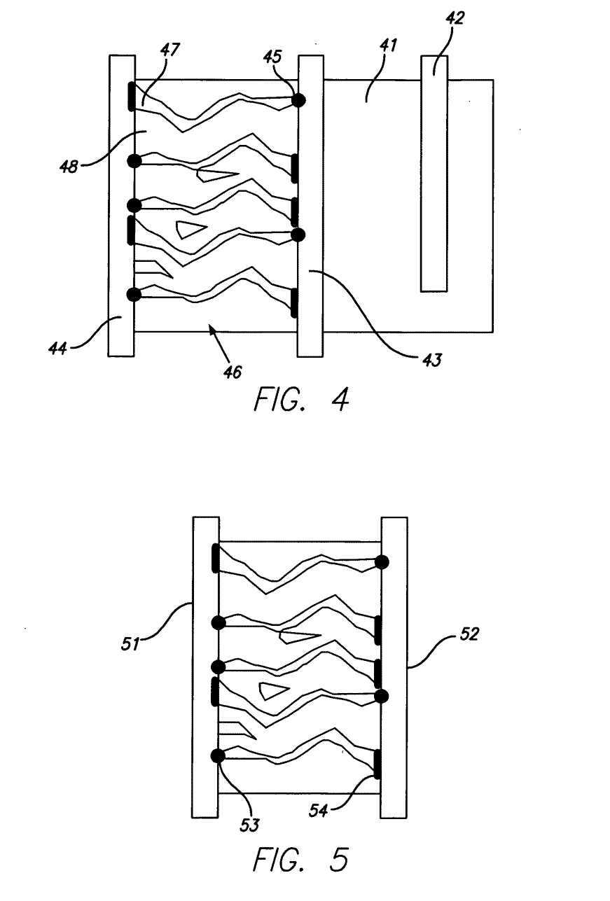

FIG. 5 is a schematic depiction of a working fuel cell prepared in accordance with this embodiment of the invention described here. For example, one can deposit a Pt/Ru catalyst 53 at the anode 51 and Pt 54 on the cathode 52 as is often done in fuel cells. However, one could deposit practically any metal, metalloid or alloy by this procedure.

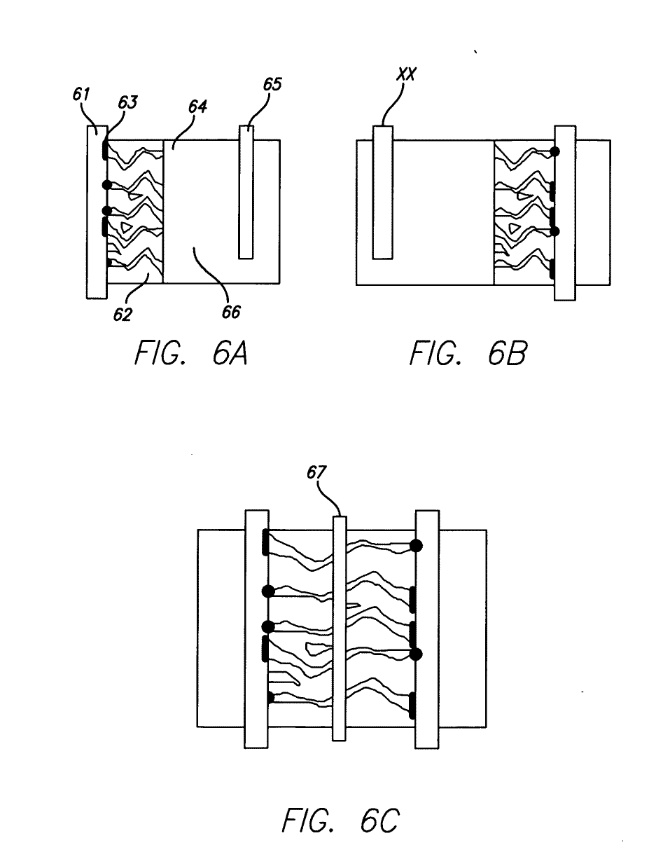

FIG. 6 shows a different way of achieving the stated goals. FIG. 6a shows a half-fuel cell in which the membrane 62 has been hot pressed (or affixed in any other manner) on the electrode 61. The electrode-membrane assembly is the put in contact with an electrolyte solution 66 containing the element (metal, metalloid) to be deposited on 61. The assembly is connected to the electrode 61 and the counter electrode 65 so as to drive the ions from the electrolyte solution 66 through the conducting channels 64 of the membrane 62 to the electrode 61 where metal or metalloid is deposited. One deposited particle is shown by 63. During deposition all faces of the membrane are covered with tape except for the face opposite to 61 (in contact with electrolyte 66). This procedure places catalyst particles only at the end of channels crossing the membrane. The procedure is repeated with the half-cell and electrode (XX) shown in FIG. 6b. This uses a different (or the same) electrolyte solution than the operation described in FIG. 6a, to deposit a different (or the same) metal or metalloid particle. After the catalyst deposition described above the two half-cells are joined using a coupling layer composed of a material that is porous allowing free exchange of ions including but not limited to, porous silica, mesoporous alumina, or silica fibers, or, ion selective gels or other ionic exchange materials (67) in a split-join synthesis of the fuel cell.

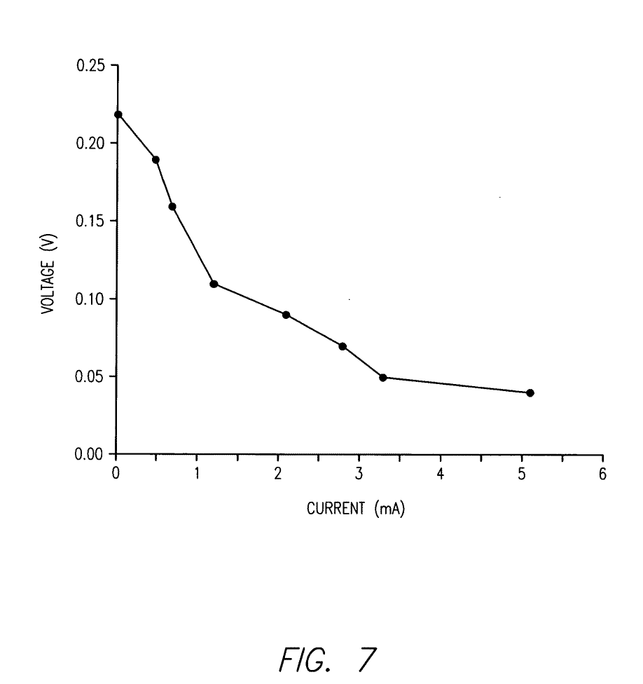

FIG. 7 is a plot of voltage versus current for a fuel cell of this embodiment, showing characteristics of the fuel cell (as a H₂ fuel cell). The area of the cell is 6.25 cm². The amount of Pt deposited on each electrode is 9.22 and 9.24 μg respectively.

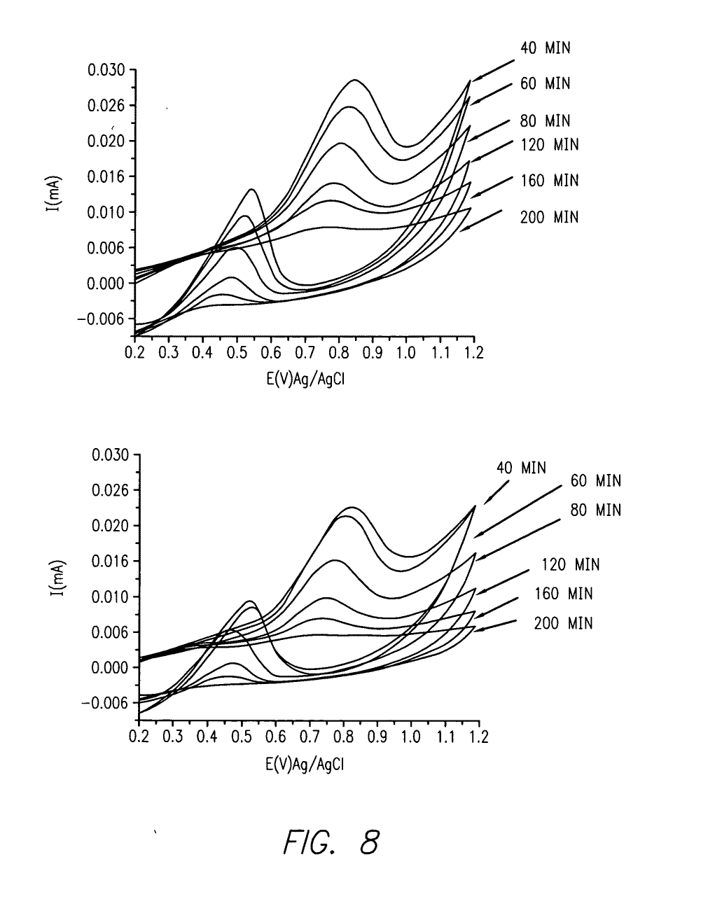

FIG. 8 shows, separately, the cyclic voltammetry for oxidation of methanol (in 0.5M CH₃OH/0.5M H₂SO₄) for each electrode (top—anode, bottom cathode) at different deposition times. Data reflects the increasing current density as the mass of catalyst increases on the electrode.

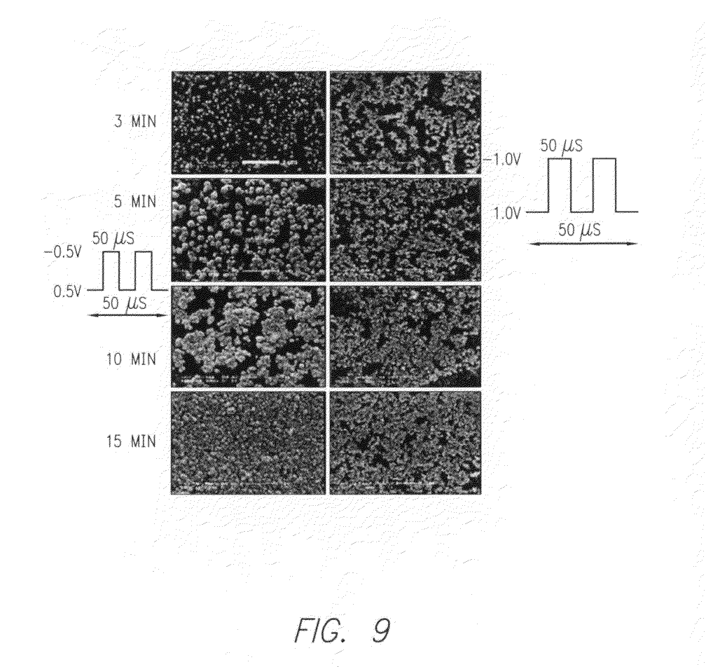

FIG. 9 depicts a series of scanning electron micrographs showing evidence of smaller particle size with increased surface area obtained by decreasing the pH of the electrolyte. Left column images were obtained from samples deposited at pH=2.9 at increasingly long deposition times (top to bottom), Right column images were obtained from samples deposited at pH=0.5 at increasingly long deposition times (top to bottom). Upon decreasing the pH a more fractal, porous, surface is observed.

The present invention has several distinct advantages over existing technology:
There is minimal noble metal loading by depositing materials only at sites where they are in contact with the conducting channels in the membrane. Accordingly, no rare and expensive noble metals such as platinum are wasted.
The grain size of the material particles can be controlled and optimized for maximizing current density in the cell, by varying the shape of the pulsed voltage during deposition, the maximum and the minimum voltage, the composition of the electrolyte solution from which the catalyst is deposited and the deposition time. We can also combine pulse deposition, for good nucleation, with continuous voltages for subsequent growth of the deposits.
The complete fuel cell is constructed as a unit using low cost electrochemical means. This provides for rapid, reliable, and low cost mass manufacturing. In addition, the device may be effectively tested during its construction by CV analysis, allowing parallel quality control.
The minimized amount of noble metal catalyst per square centimeter will be between a factor of 10³ to 10⁶, without altering the performance of the cell, thus reducing the cost of the materials.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims.

1. A method of forming an electrochemical device comprising a membrane having ion conduction channels, opposing first and second electrodes, and electrocatalyst material on membrane-facing surfaces of the electrodes, the method comprising:
assembling a combination of at least one of said electrodes and said membrane;
applying a counter electrode to said combination opposite said electrode; and
applying an electrolyte to the membrane, the electrolyte containing an electrochemical precursor to the electrocatalyst, whereby, upon applying current to the counter electrode, to deposit electrocatalyst on locations on the first electrode corresponding to the ion conduction channels.

2. The method of claim 1 in which the membrane comprises an ionomer.

3. The method of claim 2 in which the ionomer is a sulfonated tetrafluoroethylene copolymer.

4. The method of claim 1 in which the electrochemical precursor comprises any salt or compound from which a catalyst can be deposited on the electrodes of the fuel cell.

5. The method of claim 1 in which the electrochemical device is a fuel cell.

6. A method of forming an electrochemical device comprising a membrane having ion conduction channels, opposing first and second electrodes on opposite facing surfaces of the membrane, and electrocatalyst material on the membrane-facing surfaces of the electrodes, the method comprising:
assembling a combination of said electrodes sandwiching said membrane;
applying a counter electrode to second electrode;
applying an electrolyte to the membrane, the electrolyte containing an electrochemical precursor to the electrocatalyst, whereby, upon applying current to the counter electrode, to deposit electrocatalyst on locations on the first electrode corresponding to the ion conduction channels;
applying a counter electrode to the first electrode; and
applying an electrolyte to the membrane, the electrolyte containing an electrochemical precursor to the electrocatalyst, whereby, upon applying current to the counter electrode, to deposit electrocatalyst on locations on the second electrode corresponding to the ion conduction channels.

7. The method of claim 6 in which the electrodes are respectively anode and cathode and the electrochemical device is a fuel cell.

8. A method of forming an electrochemical device comprising a membrane having ion conduction channels, opposing first and second electrodes for the membrane, and electrocatalyst material on membrane-facing surfaces of the electrodes, the method comprising:
assembling a combination of a first electrode and a first membrane and a combination of a second electrode and a second membrane;
applying a counter electrode to the first membrane;
applying an electrolyte to the membrane, the electrolyte containing an electrochemical precursor to the electrocatalyst, whereby, upon applying current to the counter electrode, to deposit electrocatalyst on locations on the first electrode corresponding to the ion conduction channels;
applying a counter electrode to the second membrane;
applying an electrolyte to the membrane, the electrolyte containing an electrochemical precursor to the electrocatalyst, whereby, upon applying current to the counter electrode, to deposit electrocatalyst on locations on the second electrode corresponding to the ion conduction channels; and
joining surfaces of the first and second membranes opposite their respective electrodes to a porous coupling layer to form the electrochemical device.

9. The method of claim 8 in which the electrodes are respectively anode and cathode and the electrochemical device is a fuel cell.

10. An electrochemical device comprising:
a membrane having ion conduction channels; and
opposing first and second electrodes having respective membrane facing surfaces;
the surface of each of said electrodes having electrocatalyst thereon at locations corresponding to respective ion conduction channels.

11. The device of claim 10 in which the membrane comprises an ionomer.

12. The device of claim 11 in which the ionomer is a sulfonated tetrafluoroethylene copolymer.

13. The device of claim 10 in which the electrodes are respectively anode and cathode and the electrochemical device is a fuel cell.

14. An electrochemical device comprising:
first and second membranes having ion conduction channels;
opposing first and second electrodes having respective membrane facing surfaces for respective first and second membranes; and
a porous coupling layer between the membranes;
the surface of each of said electrodes having electrocatalyst thereon at locations corresponding to respective ion conduction channels.

15. The device of claim 14 in which the membrane comprises an ionomer.

16. The device of claim 15 in which the ionomer is a sulfonated tetrafluoroethylene copolymer.

17. The device of claim 15 in which the electrodes are respectively anode and cathode.

18. The device of claim 17 in which the electrochemical device is a fuel cell.
